(19) United States
(12) Patent Application Publication
(10) Pub. No.: US 2026/0251436 A1
(43) Pub. Date: Aug. 27, 2026

(54) DOOR LOCK POKAYOKE TOOLS FOR CONFIRMING CORRECT ASSEMBLY OF VEHICLE DOOR HANDLES HAVING A LOCK PORTION AND A HOUSING

(71) Applicant: Toyota Motor Engineering & Manufacturing North America, Inc., Plano, TX (US)

(72) Inventors: David G. Wiese, Nicholasville, KY (US); Tyler R. Moore, Stamping Ground, KY (US); William C. Miller, Lexington, KY (US)

(73) Assignees: Toyota Motor Engineering & Manufacturing North America, Inc., Plano, TX (US); Toyota Jidosha Kabushiki Kaisha, Aichi-Ken (JP)

(21) Appl. No.: 19/060,564

(22) Filed: Feb. 21, 2025

(51) Int. Cl. G01B 5/18; E05B 79/08; G01B 5/00; E05B 79/06; E05B 79/20

(52) U.S. Cl. CPC G01B 5/18; E05B 79/08; G01B 5/0025; E05B 79/06; E05B 79/20

(57) ABSTRACT

A door lock pokayoke tool for confirming correct assembly of a vehicle door handle having a lock portion and a housing. The door lock pokayoke tool includes a handle configured to be grasped by an operator. The door lock pokayoke tool includes a feeler tip jig extending along an axis from the handle and configured to be inserted into a cavity between the lock portion and the housing. The feeler tip jig is sized to be fully disposed within the cavity when vehicle door handle is correctly assembled. The door lock pokayoke tool includes a plunger coupled to the handle and disposed adjacent the feeler tip jig. The plunger is configured to engage a portion of the vehicle door handle when the feeler tip jig is fully disposed within the cavity and is configured to produce an output indicating that the vehicle door handle is correctly assembled.

### TECHNICAL FIELD

The present specification generally relates to door look pokayoke tools and, more specifically, door lock pokayoke tools for confirming correct assembly of vehicle door handles having a lock portion and a housing.

### BACKGROUND

Vehicle doors typically include a handle assembly. The handle assembly includes a handle housing defining a cavity and a lock housing that is disposed within the cavity and moveable relative to the handle housing. The lock housing functions to operate a lock of the vehicle door. The handle assembly further includes a cable that extends to a distal end and has a ball mounted thereto. The lock housing includes an aperture that is sized to receive the ball therein and connect the cable to the lock housing. The cable may be configured for pushing and/or pulling the lock housing to move the lock housing relative to the handle housing.

During assembly of the vehicle door, the ball is inserted into the aperture to connect the cable to the lock housing. When properly installed, the ball is fully disposed within the aperture. However, when improperly installed, the ball is only partially disposed within the aperture. In this scenario, the lock of the vehicle door will not function properly. Detecting the improperly installed handle assembly requires a visual inspection by an assembly technician.

Accordingly, a need exists for door lock pokayoke tools for confirming correct assembly of vehicle door handles having a lock portion and a housing.

### SUMMARY

In one embodiment, a door lock pokayoke tool for confirming correct assembly of a vehicle door handle having a lock portion and a housing may include a handle configured to be grasped by an operator. The door lock pokayoke tool may include a feeler tip jig extending along an axis from the handle and configured to be inserted into a cavity between the lock portion and the housing. The feeler tip jig is sized to be fully disposed within the cavity when vehicle door handle is correctly assembled. The door lock pokayoke tool may include a plunger coupled to the handle and disposed adjacent the feeler tip jig. The plunger is configured to engage a portion of the vehicle door handle when the feeler tip jig is fully disposed within the cavity and is configured to produce an output indicating that the vehicle door handle is correctly assembled.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a door lock pokayoke tool and a vehicle door handle, according to one or more embodiments shown and described herein;

FIG. 2 schematically depicts a perspective view of the door lock pokayoke tool and the vehicle door handle of FIG. 1, showing the door lock pokayoke tool engaging the vehicle door handle , according to one or more embodiments shown and described herein; and

FIG. 3 schematically depicts a plan view of the door lock pokayoke tool of FIG. 1 and an external receiver, according to one or more embodiments shown and described herein.

### DETAILED DESCRIPTION

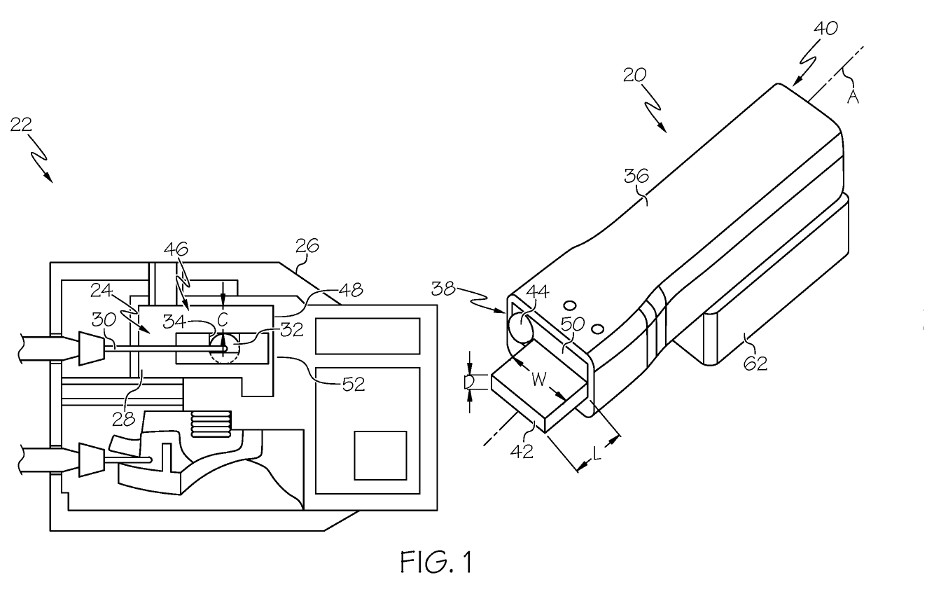

FIG. 1 generally depicts a door lock pokayoke tool and a vehicle door handle having a lock portion and a housing. The door lock pokayoke tool confirms correct assembly of the vehicle door handle. The door lock pokayoke tool includes a handle configured to be grasped by an operator. The door lock pokayoke tool includes a feeler tip jig extending along an axis from the handle and configured to be inserted into a cavity between the lock portion and the housing. The feeler tip jig is sized to be fully disposed within the cavity when vehicle door handle is correctly assembled. The door lock pokayoke tool includes a plunger coupled to the handle and disposed adjacent the feeler tip jig. The plunger is configured to engage a portion of the vehicle door handle when the feeler tip jig is fully disposed within the cavity and is configured to produce an output indicating that the vehicle door handle is correctly assembled.

Previous ways of determining when the vehicle door handle is correctly assembled required a visual inspection by an assembly technician. However, under visual inspection, the vehicle door handle may appear to be correctly assembled, but the components of the vehicle door handle may not be completely seated in their correct positions, leading to an incorrect assembly and failure of the vehicle door handle. The sizing of the feeler tip jig to be fully disposed within the cavity ensures proper placement of the components of the vehicle door handle. Furthermore, the output produced when the feeler tip jig is fully disposed within the cavity provides confirmation that the feeler tip jig was used correctly and thus the vehicle door handle is correctly assembled.

Referring now to FIG. 1, a door lock pokayoke tool 20 and a vehicle door handle 22 in accordance with one or more embodiments of the present disclosure are shown. In some embodiments, the vehicle door handle 22 may be configured to be mounted to a door of a vehicle and allow for selective opening and locking of the door. However, in other embodiments the vehicle door handle 22 may be configured to be mounted to a hood, a trunk, a hatch, or any other panel that is movably coupled to the vehicle.

With continued reference to FIG. 1, the vehicle door handle 22 includes a lock portion 24 and a housing 26. The lock portion 24 includes a lock body 28 moveable relative to the housing 26. The lock body 28 functions to operate a lock of the door. The lock portion 24 further includes a cable 30 that extends to a distal end and has a ball 32 mounted thereto. The lock body 28 defines an aperture 34 that is sized to receive the ball 32 therein and connect the cable 30 to the lock body 28. The cable 30 may be configured for pushing and/or pulling the lock body 28 to move the lock body 28 relative to the housing 26.

During assembly of the vehicle door handle 22 to the door, the ball 32 is inserted into the aperture 34 to connect the cable 30 to the lock body 28. When properly assembled, the ball 32 is fully disposed within the aperture 34 (as shown in FIG. 1). However, when improperly assembled, the ball 32 is only partially disposed within the aperture 34. In this scenario, the lock of the vehicle door will may not operate properly.

The door lock pokayoke tool 20 confirms correct assembly of the vehicle door handle 22. The door lock pokayoke tool 20 may include a handle 36 configured to be grasped by an operator. In the embodiment shown in FIGS. 1-3, the handle 36 is configured generally as a rectangular prism that extends longitudinally between a first end 38 and a second end 40. It is to be appreciated that the handle 36 may have any suitable shape and configuration.

With reference to FIG. 1, the door lock pokayoke tool 20 may further include a feeler tip jig 42 extending along a longitudinal axis A of the handle 36 and a plunger 44 coupled to the handle 36 and disposed adjacent the feeler tip jig 42. The feeler tip jig 42 and the plunger 44 are disposed at the first end 38 of the handle 36. However, the feeler tip jig 42 and the plunger 44 may be disposed at the second end 40 or along any other suitable portion of the handle 36.

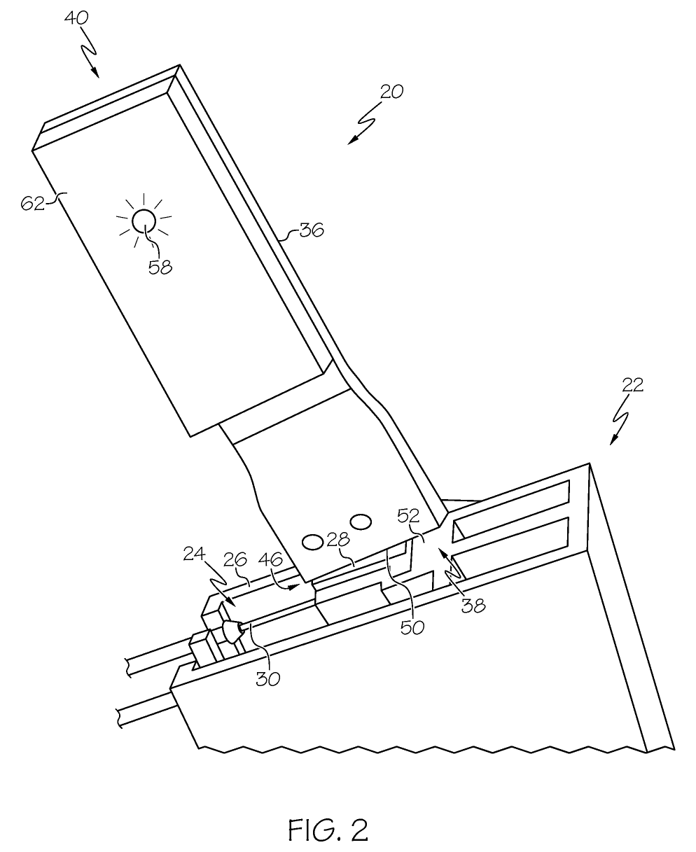

With reference continued reference to FIG. 1, The feeler tip jig 42 is configured to be inserted (see FIG. 2) into a cavity 46 between the lock portion 24 and the housing 26, the feeler tip jig 42 sized to be fully disposed within the cavity 46 when vehicle door handle 22 is correctly assembled. More specifically, the cavity 46 is defined by the housing 26 and the lock body 28. As described above, the ball 32 is fully disposed within the aperture 34 when correctly assembled. Therefore, the ball 32 does not extend into the cavity 46, leaving the cavity 46 open fully receive the feeler tip jig 42 therein. When the vehicle door handle 22 is improperly assembled, the ball 32 is only partially disposed within the aperture 34. Therefore, the ball 32 at least partially extends into the cavity 46, blocking the full insertion of the feeler tip jig 42 into the cavity 46.

The plunger 44 is configured to engage a portion 48 of the vehicle door handle 22 when the feeler tip jig 42 is fully disposed within the cavity 46 and the door lock pokayoke tool 20 is configured to produce an output indicating that the vehicle door handle 22 is correctly assembled. More specifically, the handle 36 includes a reference surface 50, disposed at the first end 38. The plunger 44 and the feeler tip jig 42 are disposed along the reference surface 50. Furthermore, the reference surface 50 has a planar configuration. Therefore, fully inserting the feeler tip jig 42 into the cavity 46 causes the plunger 44 to engage the portion 48 of the vehicle door handle 22. However, the reference surface 50 may have any shape and configuration suitable for facilitating engagement of the plunger 44 with the vehicle door handle 22 when the feeler tip jig 42 is fully disposed in the cavity 46.

The disposition of the plunger 44 adjacent the feeler tip jig 42 allows the plunger 44 to engage the portion 48 of the vehicle door handle 22. More specifically, the disposition of the plunger 44 adjacent the feeler tip jig 42 positions the plunger 44 for engagement with an abutment portion 52 of the housing 26, adjacent the cavity 46 (see FIG. 1). It is to be appreciated that the plunger 44 may engage any suitable portion of the vehicle door handle 22.

With continued reference to FIG. 1, the feeler tip jig 42 comprises a length dimension L parallel to the axis A, a width dimension W orthogonal to the length dimension L (i.e., aligned with the plunger 44), and a depth dimension D orthogonal to the length dimension L and the width dimension W. At least one of the length dimension L, the width dimension W, and the depth dimension D corresponds to a dimension C of the cavity 46 of the vehicle door handle 22 indicating the correct assembly of the vehicle door handle 22. In the embodiment shown in FIG. 1, the dimension C of the vehicle door handle 22 corresponds to a width across the cavity 46 in alignment with the ball 32 when the ball 32 is fully disposed within the aperture 34. When the ball 32 is not fully disposed within the aperture 34 (and extends into the cavity 46), contact will occur between the feeler tip jig 42 and the ball 32. In this embodiment, the depth dimension D of the feeler tip jig 42 corresponds to the dimension C. Therefore, the depth dimension D of the feeler tip jig 42 is sized to be substantially equal to the dimension C in order to ensure the ball 32 is fully disposed within the aperture 34. In one example, the depth dimension D is within 0.5 mm of the dimension C. In another example, the depth dimension D is within 1 mm of the dimension C. In yet another example, the depth dimension D is within 2 mm of the dimension C.

The plunger 44 in the embodiment shown in FIGS. 1-3 is configured to translate along the axis A upon engagement with the portion 48 of the vehicle door handle 22. Therefore, the translation of the plunger 44 is indicative of engagement with the portion 48 of the vehicle door handle 22. The plunger 44 may be biased away from the handle 36 such that the plunger 44 is moved by force against the bias when the plunger 44 engages the portion 48 of the vehicle door handle 22. It is to be appreciated that the plunger 44 may be move in any suitable manner and direction. Moreover, in other examples the plunger 44 may be devoid of movement such that engagement is determined simply by contacting the portion 48 of the vehicle door handle 22.

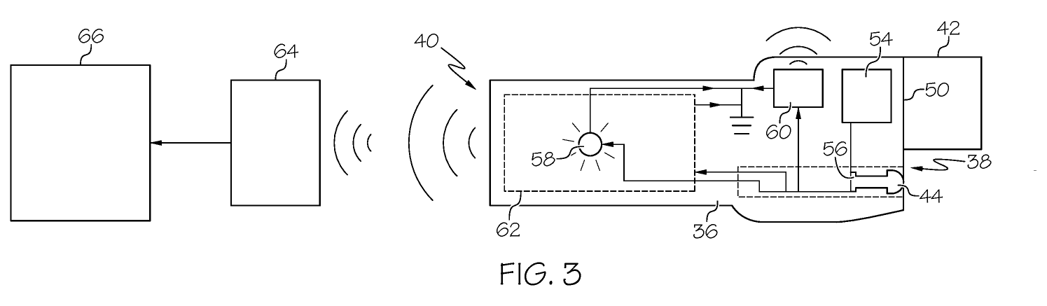

With reference to FIG. 3, the door lock pokayoke tool 20 may further include a power source 54. In some embodiments, the power source 54 is configured as a battery disposed within the handle 36. In other embodiments, the power source 54 is configured as a plug that may engage an outlet. It is to be appreciated that any suitable power source 54 may be utilized.

The plunger 44 may move upon engagement with the portion 48 of the vehicle door handle 22. In turn, the plunger 44 may engage a switch 56 (see FIG. 3) and upon engagement of the plunger 44 with the switch 56 the output is produced. The power source 54 may be electrically coupled to the switch 56. Therefore, the engagement of the switch 56 by the plunger 44 may create an electrical signal that produces the output.

The door lock pokayoke tool 20 may further include a light 58. The light 58 may be coupled to the handle 36 and may be in communication with the plunger 44. More specifically, the light 58 may be electrically coupled to the switch 56 and configured to receive the electrical signal when the switch 56 is engaged by the plunger 44 to produce a visual output from the light 58. Therefore, the output may include illumination of the light 58.

With continued reference to FIG. 3, the door lock pokayoke tool 20 may further include an auditory emitter 60 (e.g., a speaker). The auditory emitter 60 may be mounted internally within the handle 36 and may be in communication with the plunger 44. More specifically, the auditory emitter 60 may be electrically coupled to the switch 56 and configured to receive the electrical signal when the switch 56 is engaged by the plunger 44 to produce an audio output. Therefore, the output may include a sound emission by the auditory emitter 60 (such as a beep, buzz, honk, etc.).

In the embodiment shown in FIG. 3, the light 58 and the auditory emitter 60 are both electrically coupled to the switch 56 such that the light 58 illuminates and the auditory emitter 60 emits sound when the plunger 44 engages the portion 48 of the vehicle door handle 22. In doing so, the operator receives visual and auditory confirmation that the vehicle door handle 22 is assembled correctly. It is to be appreciated that only one of the light 58 and the auditory emitter 60 may be utilized.

The door lock pokayoke tool 20 may further include a transmitter 62. The transmitter 62 is shown in FIGS. 1 and 2 to be mounted externally to the handle 36, adjacent the second end 40. However, the transmitter 62 may be mounted anywhere along or within the handle 36. The transmitter 62 may be in communication with the plunger 44 to produce the output when the plunger 44 engages the switch 56. The output may including a wireless signal emitted by the transmitter 62. With reference to FIG. 3, the transmitter 62 may be configured to establish wireless communication with an external receiver 64 outside of the door lock pokayoke tool 20. The wireless communication may performed through a Wi-Fi network, a personal area network (e.g., Bluetooth®), a cellular network, a satellite network, a radio network, or any other suitable wireless communication protocol. More specifically, the transmitter 62 may be electrically coupled to the switch 56 and configured to receive the electrical signal when the switch 56 is engaged by the plunger 44. Therefore, the output may include a wireless signal emitted by the transmitter 62.

With continued reference to FIG. 3, the external receiver 64 is in communication with an electronic control unit 66. When the external receiver 64 receives the wireless signal from the transmitter 62, the external receiver 64 emits an output signal to the electronic control unit 66 indicating the vehicle door handle 22 is correctly assembled. When the electronic control unit 66 does not receive the output signal (e.g., after designated amount of time), the electronic control unit 66 may determine that the vehicle door handle 22 is incorrectly assembled. The electronic control unit 66 may catalog that the vehicle door handle 22 is incorrectly assembled. Furthermore, the electronic control unit 66 may stop the progression of the vehicle through the assembly process (e.g., stop the moving assembly line) to allow the operator to correctly assemble the vehicle door handle 22.

It should now be understood that embodiments of the present disclosure are directed to a door lock pokayoke tool for confirming correct assembly of a vehicle door handle having a lock portion and a housing. The door lock pokayoke tool includes a handle configured to be grasped by an operator. The door lock pokayoke tool includes a feeler tip jig extending along an axis from the handle and configured to be inserted into a cavity between the lock portion and the housing. The feeler tip jig is sized to be fully disposed within the cavity when vehicle door handle is correctly assembled. The door lock pokayoke tool includes a plunger coupled to the handle and disposed adjacent the feeler tip jig. The plunger is configured to engage a portion of the vehicle door handle when the feeler tip jig is fully disposed within the cavity and is configured to produce an output indicating that the vehicle door handle is correctly assembled. The sizing of the feeler tip jig to be fully disposed within the cavity ensures proper placement of the components of the vehicle door handle. Furthermore, the output produced by the plunger when the feeler tip jig is fully disposed within the cavity provides confirmation that the feeler tip jig was used correctly and thus the vehicle door handle is correctly assembled.

It is noted that the terms "substantially" and "about" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A door lock pokayoke tool for confirming correct assembly of a vehicle door handle having a lock portion and a housing, the door lock pokayoke tool comprising:
a handle configured to be grasped by an operator;
a feeler tip jig extending along an axis from the handle and configured to be inserted into a cavity between the lock portion and the housing, the feeler tip jig sized to be fully disposed within the cavity when vehicle door handle is correctly assembled; and
a plunger coupled to the handle and disposed adjacent the feeler tip jig, the plunger is configured to engage a portion of the vehicle door handle when the feeler tip jig is fully disposed within the cavity and is configured to produce an output indicating that the vehicle door handle is correctly assembled.

2. The door lock pokayoke tool of claim 1, further comprising a light in communication with the plunger, the output including illumination of the light.

3. The door lock pokayoke tool of claim 1, further comprising an auditory emitter in communication with the plunger, the output including a sound emission by the auditory emitter.

4. The door lock pokayoke tool of claim 1, further comprising a transmitter in communication with the plunger, the output including a wireless signal emitted by the transmitter.

5. The door lock pokayoke tool of claim 1, wherein the plunger moves upon engagement with the portion of the vehicle door handle and engages a switch to produce the output.

6. The door lock pokayoke tool of claim 5, further comprising a power source electrically coupled to the switch, engagement of the switch creates an electrical signal that produces the output.

7. The door lock pokayoke tool of claim 1, wherein the handle includes a reference surface, the plunger and the feeler tip jig disposed along the reference surface.

8. The door lock pokayoke tool of claim 7, wherein the reference surface has a planar configuration.

9. The door lock pokayoke tool of claim 1, wherein the feeler tip jig comprises a length dimension parallel to the axis, a width dimension orthogonal to the length dimension, and a depth dimension orthogonal to the length dimension and the width dimension, at least one of the length dimension, the width dimension, and the depth dimension corresponding to a dimension of the vehicle door handle indicating the correct assembly of the vehicle door handle.

10. The door lock pokayoke tool of claim 1, wherein the plunger translate along the axis upon engagement with the portion of the vehicle door handle.
